(19) United States
(12) Patent Application Publication
(10) Pub. No.: US 2004/0147664 A1
(43) Pub. Date: Jul. 29, 2004

(54) Overcoat layer composition and organic photoreceptor using the same

(75) Inventors: Nam-jeong Lee, Suwon-si (KR); Hae-ree Joo, Seoul (KR); Kyung-yol Yon, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/715,139

(22) Filed: Nov. 18, 2003

(30) Foreign Application Priority Data
Nov. 28, 2002 (KR) 2002-74640

(51) Int. Cl. G03G 17/04; C08K 3/00

(52) U.S. Cl. 524/507; 524/589; 430/32

(57) ABSTRACT

An overcoat layer composition for an organic photoreceptor and an organic photoreceptor using the overcoat layer composition. The overcoat layer composition has improved electric and mechanical properties to be suitably used for an electrophotographic development system. The overcoat layer composition includes anionic aqueous polyurethane dispersion and a fluorine resin.

### CROSS-REFERENCE TO RELATED APPLICATIONS

This application claims the benefit of Korean Patent Application No. 2002-74640, filed on Nov. 28, 2002, in the Korean Intellectual Property Office, the disclosure of which is incorporated herein by reference.

### BACKGROUND OF THE INVENTION

1. Field of the Invention

The present invention relates to an overcoat layer composition for an organic photoreceptor and an organic photoreceptor using the same, and more particularly, to an overcoat layer composition for an organic photoreceptor having improved electrical and mechanical properties so as to be suitably used for an electrophotographic development system and an organic photoreceptor using the same.

2. Description of the Related Art

In recent years, there has been a growth in the development of electrophotographic printers using liquid toner creating an increase in the demand for the development of organic photoreceptors for liquid toner.

In a positively charged organic photoreceptor, the surface of the photoreceptor is charged with positive (+) charges and irradiated with a laser beam. Positive and negative charges are generated at a charge generating layer, and the positive charges (holes) are injected into a charge transport layer, by an electric field applied to the organic photoreceptor layer, and then migrate to an electrically conductive support. The negative charges (electrons) migrate to a surface layer to neutralize surface charges, reducing a surface potential at an exposed portion, thereby forming a latent image and developing the latent image using toner.

The organic photoreceptor can be of two types: a multilayered organic photoreceptor or a single-layered organic photoreceptor. When compared to the single-layered organic photoreceptor in which a single layer must have various electrical properties, the multilayered organic photoreceptor in which functionally separated layers are disposed, the multilayered organic photoreceptor can be easily controlled in view of electrical properties thereof, including a charge potential or an exposure potential. In particular, since an electric field can be stably applied to the thin multilayered organic photoreceptor, a large amount of charge can be retained at the same electric field intensity, and thus a large amount of toner can be developed on the organic photoreceptor. Thus, the multilayered organic photoreceptor can be advantageously used for development using liquid toner having a small particle size and a large charge amount, i.e. high Q/M.

The positively charged, multilayered organic photoreceptor is basically constructed such that a charge transport layer 2 and a charge generating layer 3 are coated on an electrically conductive support 1, as shown in FIG. 1. In order to compensate for a very thin charge generating layer 3 that easily wears due to friction between toner and a cleaning blade, an overcoat layer 4 is further formed on the charge generating layer.

An organic photoreceptor should not adversely affect image quality caused by a decrease of a charge potential, and an increase of an exposure potential or residual potential due to electrical or mechanical fatigue of the organic photoreceptor during printing through repeated charge-exposure-erase cycles. However, an organic photoreceptor with an overcoat layer unavoidably experiences the above problem more severely, compared to an organic photoreceptor without an overcoat layer. Therefore, to avoid this problem, the thickness of an overcoat layer should be restricted.

However, if the overcoat layer is thin, the coated layer may be easily worn out due to the friction between the layer and a cleaning blade used with a liquid toner. Additionally, scratches may occur due to the toner or foreign matter, adversely affecting image quality.

For mass production of organic photoreceptors, dip coating of an overcoat layer should be possible. In the case of using a general organic solvent, a photosensitive layer may be damaged during dip coating, or an overcoat layer composition may be contaminated by components of the photosensitive layer eluted in the organic solvent. Also, physical properties of a photoreceptor may become uneven in a lengthwise direction due to a difference in coating solution contact time. In particular, in a multilayered positively charged organic photoreceptor comprising an electrically conductive support, a charge transport layer, a charge generating layer and an overcoat layer, the charge generating layer may be damaged during coating of the overcoat layer because of its small thickness. However, most conventional overcoat layer compositions for an organic photoreceptor aim at extending the lifespan of an organic photoreceptor for dry toner. In actual practice, however, there have been few overcoat layer compositions suitable for liquid toner.

### SUMMARY OF THE INVENTION

The present invention provides an overcoat layer composition having improved electrical and mechanical properties.

The present invention also provides an organic photoreceptor using the composition.

The present invention also provides an electrophotographic imaging process using the organic photoreceptor.

In accordance with an aspect of the present invention, there is provided an overcoat layer composition comprising anionic aqueous polyurethane dispersion and a fluorine resin.

The fluorine resin is preferably particle-shaped and the average particle size thereof is preferably 0.1 to 1 μm.

The fluorine resin may be polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), or a mixture thereof.

The fluorine resin is preferably used in an amount of 20 to 200 parts by weight per 100 parts by weight of solid content of the anionic aqueous polyurethane dispersion.

The overcoat layer composition may further comprise a fluorine containing dispersant in an amount of 1 to 10 parts by weight per 100 parts by weight of solid content of the fluorine resin.

The fluorine containing dispersant is preferably a non-ionic compound.

The anionic aqueous polyurethane dispersion may be obtained by reacting at least one acid anhydride with or without a double bond with at least one kind of triol or tetraol derivatives to prepare a diol or triol monomer, or a mixture thereof containing a carboxyl group or containing both a carboxyl group and a double bond, reacting the resulting product with polyol, and diisocyanate or diisocyanate polymer to acquire a polyurethane prepolymer, neutralizing a carboxylic group of the acquired polyurethane prepolymer using a neutralizer and dispersing the same in water, followed by chain-extending using a chain extending agent.

The neutralizer is preferably water-soluble tertiary amine, alkali metal hydroxide, or a mixture thereof.

The chain extending agent may be at least one selected from the group consisting of diol, triol, diamine, triamine, hydrazine and dihydrazide and having two reactive hydrogen atoms and having a molecular weight of 18 to 250.

The NCO content of the polyurethane prepolymer acquired is preferably 0.1 to 30%.

During dispersion, water is preferably used for the total solid content to be 5 to 80% and the temperature of water is in the range of 5 to 80° C.

The overcoat layer composition may further comprise a polymerization initiator.

The overcoat layer composition may further comprise water or a mixed solvent of water and alcohol for dilution, the water or mixed solvent being used for the total solid content of the composition to be 1 to 15%.

According to another aspect of the present invention, there is provided an organic photoreceptor comprising a photosensitive layer having an overcoat layer using the overcoat layer composition.

The overcoat layer preferably has a thickness of 0.1 to 5μm.

The photosensitive layer may have a single layered structure having a charge generating material and a charge transport material, or a dual-layered structure having a charge transport layer including a charge transport material and a charge-generating layer including a charge generating material.

According to still another aspect of the present invention, there is provided an electrophotographic imaging method using liquid toner and an organic photoreceptor for electrophotography, wherein the organic photoreceptor comprising a photosensitive layer having an overcoat layer using the overcoat layer composition.

The liquid toner may include an aliphatic hydrocarbon solvent.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of a positively charged multilayered organic photoreceptor;

FIG. 2 is a schematic sectional view of a positively charged multilayered organic photoreceptor according to the present invention;

FIG. 3 is a schematic sectional view of a positively charged single-layered organic photoreceptor according to the present invention;

FIG. 4 illustrates a charge/exposure/erase evaluating apparatus for an organic photoreceptor;

FIG. 5 illustrates an apparatus for evaluating a relative friction coefficient between an organic photoreceptor drum and a cleaning blade; and

FIG. 6 is a schematic diagram of a urethane cleaning blade contact rotation apparatus of an organic photoreceptor drum.

FIG. 7 is a schematic diagram of an image forming apparatus, an organic photoreceptor drum, and a photoreceptor cartridge in accordance with selected embodiments of the present invention.

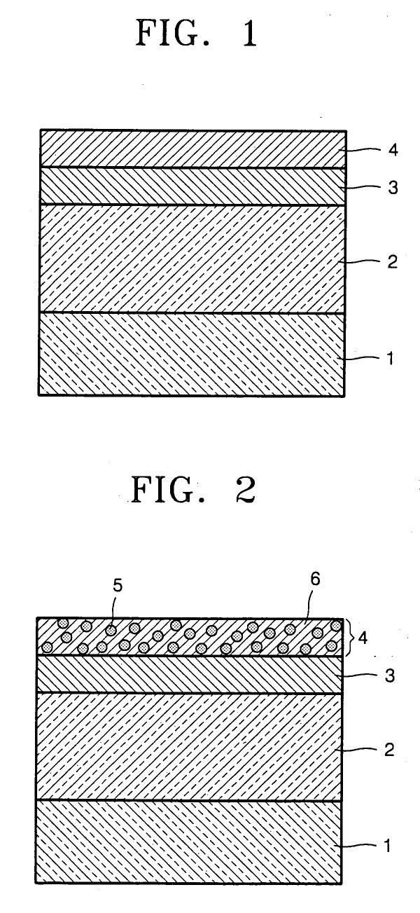

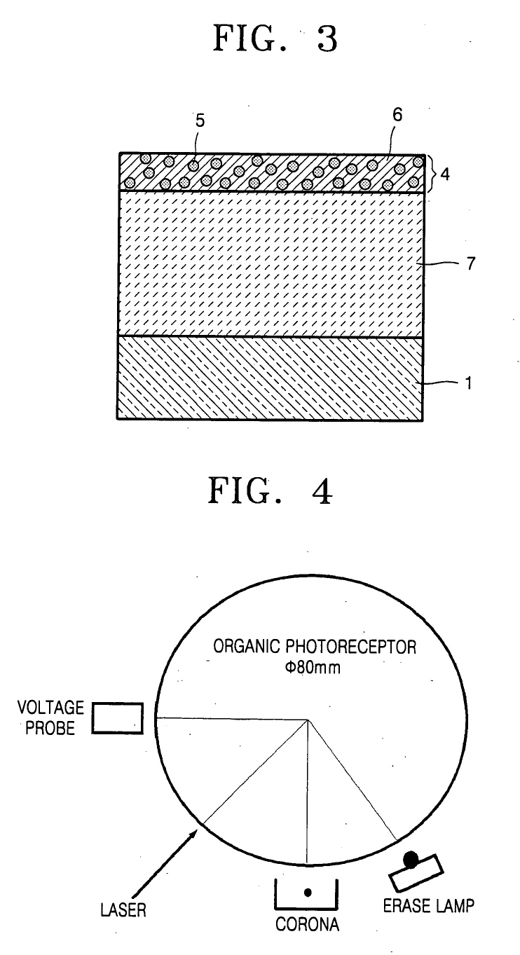

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention will now be described in more detail.

The present invention provides an overcoat layer composition formed on a photosensitive layer of an organic photoreceptor, the composition including a fluorine resin and anionic aqueous polyurethane dispersion.

The fluorine resin used for the composition reduces a friction coefficient with a cleaning blade preventing overload due to friction when the organic photoreceptor rotates, prevents the cleaning blade from bending, allows the organic photoreceptor to rotate without addition of a special lubricant, and improves cleaning performance of toner developed on the organic photoreceptor.

Any resin having a fluorine atom in its polymer structure with a lubricating function can be used without limitation. Examples thereof include polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), and a mixture thereof.

The fluorine resin is used in an amount of 20 to 200 parts by weight per 100 parts by weight of solid content of the anionic aqueous polyurethane dispersion. If the amount of the fluorine resin is less than 20 parts by weight, the lubricating function of the overcoat layer becomes poor, resulting in overload due to friction applied when the organic photoreceptor rotates or making the cleaning blade bend. If the amount of the fluorine resin is greater than 200 parts by weight, the mechanical property of the overcoat layer undesirably deteriorates because the relative content of polyurethane functioning as a binder is reduced.

The fluorine resin is not limited in its shape and a particulate fluorine resin may be used. In this case, the average particle size of the fluorine resin is preferably 0.1 to 1 μm. If the average particle size of the fluorine resin is less than 0.1 μm, dispersion of fluorine resin particles is difficult. If the average particle size of the fluorine resin is greater than 1 μm, fluorine resin particles may project from the surface of the overcoat layer, making it difficult to obtain an even film surface.

In order to homogenously disperse the fluorine resin particles, a dispersant may be further added. Nonionic, fluorine-containing dispersants are preferably used, and examples thereof include, but are not limited to, FSO, FSN, FSH and FS-300 commercially available by E.I. DU PONT. The content of the fluorine-containing dispersant is preferably in the range of 1 to 10 parts by weight based on 100 parts of solid content of the fluorine resin. If the amount of the fluorine-containing dispersant is less than 1 part by weight, the dispersing effect is not exhibited. If the amount of the fluorine-containing dispersant is greater than 10 parts by weight, the physical property of the overcoat layer undesirably deteriorates.

Usable examples of the fluorine resin having the fluorine-containing dispersant include, but are not limited to, Teflon, PTFE 30, 30B, 304A, 305A, 307A, 313A, B, 35, FPD 3584 and K-20 (manufactured by E.I. DU PONT), that are currently commercially available, or a mixture thereof.

The anionic-type aqueous polyurethane dispersion contained in the overcoat layer according to the present invention is disclosed in U.S. Pat. No. 5,863,980 to HEPCE CHEM, Korea, the content of which is incorporated in the present invention. U.S. Pat. No. 5,863,980 also discloses an aqueous polyurethane dispersion used for a coating agent, an adhesive agent, a fiber treating agent, a paper processing agent, a leather treating agent, a plywood treating agent, a cement blending agent and so on. However, use of the aqueous polyurethane dispersion as a component of an organic photoreceptor, in particular, as a component of an overcoat layer is unknown in the art.

The aqueous polyurethane dispersion can be obtained by the following steps:

(1) preparing a diol or triol monomer or a mixture thereof containing a carboxylic group or containing both a carboxylic group and a double bond;

(2) mixing the prepared diol or triol monomer or mixture thereof with polyol and reacting the resulting mixture with a diisocyanate monomer or polyisocyanate to prepare a polyurethane prepolymer; and

(3) neutralizing a carboxylic group in the polyurethane prepolymer, dispersing the polyurethane prepolymer in water and performing a chain extension reaction, giving an aqueous polyurethane dispersion.

The respective steps will now be described in more detail.

In step (1), a diol or triol monomer or a mixture thereof containing a carboxylic group or containing both a carboxylic acid and a double bond is prepared by an addition reaction of an acid anhydride, a derivative thereof or a mixture thereof with a triol or tetraol derivative or a mixture thereof having a low molecular tri-functional or a tetra-functional group. In the preparation process, there is no limitation in device and technique. One preparation method is a single-step reaction as shown in Reaction scheme 1:

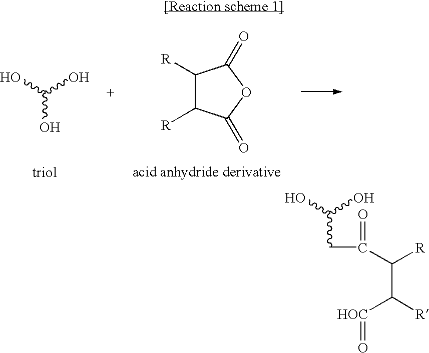

The triol or tetraol derivative used herein is preferably of either an ether type or an ester type polyol having three or four OH functional groups and having a molecular weight of 100 to 4,000. In particular, a triol derivative having a molecular weight of 100 to 1000, exemplified by trimethylolpropane (TMP), castor oil, GP-250, GP-400 or GP-280 manufactured by KOREA POLYOL CO., is preferably used. A tetraol derivative having a molecular weight of 200 to 1500 is also preferred.

Examples of the acid anhydride derivative include one having a carboxylic group only, exemplified by succinic anhydride, glutaric anhydride, methylsuccinic anhydride, hexahydro-4-methylphthalic anhydride, cis-1,2-cyclohexanedicarboxylic anhydride, diglyconic anhydride, 3-ethyl-3-methylgluconic anhydride, phthalic anhydride, 3-nitrophthalic anhydride, 4-nitrophthalic anhydride, 1,2,4-benzenetricarboxylic anhydride, homophthalic anhydride, 2,3-pyridine dicarboxylic anhydride, 3,4-pyridine dicarboxylic anhydride, and derivatives or mixtures thereof.

Examples of the acid anhydride containing both a carboxylic group and a double bond include maleic anhydride, fumaric anhydride, itaconic anhydride, bromomaleic anhydride, 3,4,5,6-tetrahydrophthalic anhydride, 2-dodecene-1-yl-succinic anhydride, cis-aconitic anhydride, and derivatives or mixtures thereof. These compounds react with polyol, forming both a double bond and a carboxylic group. In particular, the thus formed double bond greatly enhances physical properties of aqueous polyurethane dispersion by incorporating the UV or thermal curing process in the curing system of the aqueous polyurethane dispersion.

The above-described reaction is performed under a nitrogen atmosphere and at an atmospheric pressure. No particular apparatus is necessary.

As to the amount of reactants, 0.5-1 mole of acid anhydride derivative to 1 mole of triol, and 0.5-2.0 mole of acid anhydride derivative to 1 mole of tetraol are desirable.

During the reaction, a solvent is not used but a change in viscosity may occur depending on the type of acid anhydride derivative. If the reaction cannot be readily performed because of high viscosity, a solvent may be used. The solvent is removed after completion of the reaction.

The reaction temperature preferably ranges from 50° C. to 200° C., more preferably from 100° C. to 150° C.

The reaction time depends on the reaction temperature, preferably in the range between 60 minutes and 180 minutes.

The products obtained by the above reaction are generally not soluble in water. However, the products can be dispersed in water when at least a part of the carboxylic groups is neutralized by a general neutralizer (inorganic or organic base) to form ionic groups which can be dispersed in water. The process is generally known to one having ordinary skill in the art.

In step (2), a diol monomer having a carboxylic group or having both a carboxylic group and a double bond is mixed with polyol and reacted with a diisocyanate monomer or polyisocyanate in a conventional reaction condition, thereby preparing a polyurethane prepolymer.

Polyether polyol, polyester polyol or a mixture thereof is preferably used as the polyol.

Examples of the polyether polyol include various kinds of polyoxyalkylene polyols having 2˜8 hydroxyl groups and mixtures thereof. Preferably, the polyether polyol has a molecular weight of 300 to 6,500. These compounds are prepared by a generally known method, by random addition or stepwise addition through condensation of alkylene oxide (or mixture thereof) with a polyhydric initiator (or mixture thereof). Examples of the alkylene oxide include aralkylene oxides such as ethylene oxide, propylene oxide, butylene oxide, amylene oxide or styrene oxide; halogenated alkylene oxides such as chlorobutylene oxide; tetrahydrofuran; and epichlorohydrine. In particular, suitable examples of the polyether polyol prepared by the above-described method include PP-750, PP-950, PP-1000, PP-2000, PP-3000, PP-4000, GP-400, GP-280, GP-1000, GP-3000, GP-4000, and GL-3000 manufactured by KOREA POLYOL CO.

Polyester polyol can be synthesized by a reaction of polycarboxylic acid with polyhydric alcohol. Examples of the polycarboxylic acid include oxalic acid, malonic acid, succinic acid, adipinic acid, pimelic acid, subesic acid, azelaic acid, sebacinic acid, bracilic acid, taphsic acid, maleic acid, fumaric acid, glutaconic acid, α-hydromuconic acid, β-hydromuconic acid, isophthalic acid, terephthalic acid, hemimelitinic acid, 1,4-cyclohexane-dicarboxylic acid and a mixture thereof. Preferred examples of the polyhydric alcohol include ethyleneglycol, 1,3-propanediol, 1,4-buhanediol, 1,3-buthanediol, 1,2-buthanediol, 1,5-penthanediol, 1,4-penthanediol, 1,3-penthanediol, 1,6-hexanediol, 1,7-heptanediol, diethyleneglycol, triethyleneglycol, dipropyleneglycol, glycerol, 1,1,1-trimethylopropane, 1,1,1-triethyloethane, hexane-1,2,6-triol, α-ethylglucocide, penthaneerythrythiol, sorbitol and a mixture thereof.

An aromatic, aliphatic or alicylic diisocyanate is preferably used as the diisocyanate monomer, and aromatic, aliphatic or alicylic diisocyanate or polyisocyanate is preferably used as the polyisocyanate.

Examples of the aliphatic diisocyanate include hexamethylenediisocyanate, 4,4-dicyclohexylmethane diisocyanate, 1,4-tetramethylene diisocyanate, 1,10-decamethylene diisocyanate, isophoron diisocyanate, 1,4-cyclohexane diisocyanate and mixtures thereof. Examples of the aromatic diisocyanate include toluene-2,4-diisocyanate, toluene-2,6-diisocyanate, 1,5-naphthalene diisocyanate, 4-methoxy-1,3-phenylene diisocyanate, 4-chloro-1,3-phenylene diisocyanate, 2,4-dimethyl-1,3-phenylene diisocyanate, 4,4-diisocyanate diphenylether, benzydine diisocyanate, 4,4′-diisocyanate dibenzyl, methylene-bis(4-phenylisocyanate)-1,3-phenylene diisocyanate and a mixture thereof.

The above-described reaction can be performed without a solvent. However, the reaction may also be performed in the presence of a water-miscible solvent without any reactive hydrogen in an amount of up to 30% by weight of the reaction system.

The NCO content of the prepolymer acquired in the present invention is preferably 0.5 to 30%. In this case, the molecular weight of the NCO-prepolymer ranges approximately from 200 to approximately 8,000. The ratio of isocyanate group (NCO) to hydroxy (OH) group of the reactant is preferably from 0.5:1 to 5:1, and more preferably from 1.1:1 to 2:1. The reaction temperature is preferably in the range of 25° C. to 150° C., and more preferably 25° C. to 100° C. Although a reaction of NCO with a carboxylic group may occur, the reaction is slower than the reaction between the NCO group and the OH group. Under this reaction condition, some cross linkage may be formed by amide bonds resulting from the reaction of NCO with COOH. In practice, some cross linkage occurs in the stage of forming the polyurethane prepolymer.

In step (3), that is, the operation of forming aqueous polyurethane dispersion, the formed polyurethane prepolymer can be easily converted into aqueous polyurethane dispersion that is soluble in water. This operation is generally performed by (a) neutralizing carboxylic group(s) with a neutralizer; (b) adding water to disperse the neutralized prepolymer; and (c) performing a chain-extension reaction of the dispersed prepolymer with water or with diamine, diol, triol, triamine having an amine group having at least one reactive hydrogen per nitrogen atom, or a mixture thereof. The respective operations may be performed simultaneously.

During the neutralization, although a general neutralizer can be used, a water-soluble tertiary amine, alkali metal hydroxide or a mixture thereof is preferably used. In other words, triethylamine, sodium hydroxide or potassium hydroxide is preferably used as a neutralizer. The neutralizer is most preferably added in an amount enough to neutralize all the carboxylic groups contained in the prepolymer, more preferably in an amount enough to neutralize approximately 50% of the whole amount of carboxylic groups contained in the prepolymer. In other words, the molar ratio of carboxylic group to the neutralizer preferably ranges from 1:0.5 to 1:1.2.

Although the amount of water used varies depending on the application field of the dispersion, it is preferable that water be in an amount where the solid content of the finally formed dispersion is 5% to 80%. Here, the temperature of water is preferably in a range of 5 to 80° C.

The chain extension is performed by adding a chain extending agent to the NCO-prepolymer that can exist in an aqueous solution for a certain duration. The chain extending agent is preferably a compound having two reactive hydrogen atoms with a molecular weight of 18 to 250. Examples of the chain extending agent include water, diol, triol, diamine, triamine, hydrazine and dihydrazide. Examples of the preferred chain extending agent include ethylene diamine, isophorondiamine, ethylene glycol, diethylene glycol, 1,4-buthanediol, mellamine, diethylene triamine (DETA) and triethylene tetraamine (TETA).

In addition to the neutralizer and the chain extending agent used in forming the aqueous polyurethane dispersion, other additives including thickening agents, pH adjusting agents, defoaming agents or the like may be further added. As a thickening agent, methylcellulose, hydroxyethylcellulose, polyacryl emulsion, alkali or gums may be properly used.

Further, in the dispersion according to the present invention, fillers, plasticizers, pigments, carbon black, silica sol, aluminum clay, or asbestos dispersions may also be dispersed.

In particular, a thermal curing initiator, a UV curing initiator, or a mixture thereof may be added to aqueous polyurethane dispersion using diol monomer containing a carboxylic group and a double bond. If required, a thermal curing chain extending agent or a UV curing chain extending agent may also be added to aqueous polyurethane dispersion using diol monomer containing a carboxylic group and a double bond.

A thermal curing initiator which initiates at a temperature ranging from 50° C. to 200° C. may be preferably selected from organic or inorganic peroxides, azo compounds, hydroperoxides, organic metals, or mixtures thereof. The initiator is preferably added in an amount of 0.01% to 1% by mole to the whole molar amount of the carboxylic group containing a double bond and the chain extending agent.

Examples of the UV curing initiator include benzoin compounds such as benzoin, benzoinmethylether, benzoinethylether, benzoinisobutylether or benzoinoctylether; carbonyl compounds such as benzyl, diacetyl, diethoxyacetophenone, 2,2-diethoxy-2-phenylacetophenone, 2-hydroxy-2-methylpropiophenone, 4′-isopropyl-2-hydroxy-2-methylpropiophenone, methylhydraquinone, acetophenone, benzophenone, benzoyl formic methyl, benzyldimethylketal, 1-hydroxycyclohexylphenylketone, 2-methyl-1-(4-methylthiophenyl)-2-morpolyno-propene-1; sulfur compounds such as diphenyldisulfide or dithiocarbamate; naphthalene compounds such as α-methylnaphthalene chloride; condensed aromatic hydrocarbons such as anthracene; and metal salts such as iron chloride. The UV curing initiator initiates at the wavelength range of approximately 180 to approximately 460 nm. The initiator is preferably added in an amount of approximately 0.01 to 20 parts by weight per 100 parts by weight of the whole amount of the carboxylic group containing a double bond and an optionally added chain extending agent. As a UV source for emitting UV light in the wavelength range of 180 to 460 nm, a low-pressure mercury lamp, a medium-pressure mercury lamp, a high-pressure mercury lamp, an ultrahigh-pressure mercury lamp, a xenon mercury lamp, an UV fluorescent lamp, a carbon arc, a non-electrode microwave type UV lamp, or the like is preferably used.

A thermal curing, or a UV curing chain extending agent may be selected from the group consisting of acrylate derivatives, styrene, acrylonitrile, vinylchloride and mixtures thereof. The thermal curing, or UV curing chain extending agent is preferably used in an amount of 0.01 to 1% by weight of the overall solid content except water.

The overcoating composition may further include water or a mixed solvent of water and alcohol, and may be used for the total solid content of the overcoating composition to be 1 to 15%. If the solid content is less than 1% by weight, the overcoat layer is too thin to perform an intrinsic function as an overcoat layer, that is, a function of exhibiting abrasion resistance. If the solid content is greater than 15% by weight, the overcoat layer is too thick such that an exposure potential is high and increases as cycling proceeds.

As the alcohol, any alcohol that is generally used in the industry can be used without limitation, and examples of the useful alcohol include methanol, ethanol, propanol, isopropanol, butanol and t-butanol.

In accordance with another aspect of the present invention, there is provided an organic photoreceptor comprising a photosensitive layer having an overcoat layer, wherein the composition is formed on the photosensitive layer.

The overcoat layer is obtained by coating the composition containing the aqueous polyurethane dispersion on the photosensitive layer and drying.

The thickness of the overcoat layer is preferably in the range of 0.1 to 5 μm. If the thickness of the overcoat layer is less than 0.1 μm, the underlayer protecting capability of the overcoat layer is weakened. If the thickness of the overcoat layer is greater than 5 μm, electrical properties of the overcoat layer, including increased exposure potential, undesirably deteriorate.

The photosensitive layer has a single layered structure having both a charge generating material and a charge transport material on an electrically conductive support, or a dual-layered structure having a charge transport layer formed on an electrically conductive support and a charge generating layer formed on the charge transport layer.

A method of manufacturing an electrophotographic organic photoreceptor using the overcoat layer composition according to the present invention will now be described.

First, a photosensitive layer is formed on an electrically conductive support. The photosensitive layer may be formed by sequentially stacking a charge transport layer containing a charge transport material, and a charge generating layer containing a charge generating material. Otherwise, the photosensitive layer may have a single layered structure containing a charge transport material and a charge generating material.

The charge transport layer is formed by coating a composition including a charge transport material, a binder and an organic solvent, and drying the resultant structure. The charge generating layer is formed by coating a composition including a charge generating material, a binder and an organic solvent, and drying the resultant structure.

Examples of the charge transport material useful in the present invention include pyrazoline derivatives, fluorene derivatives, oxadiazole derivatives, stilbene derivatives, hydrazone derivative, carbazol hydrazone derivatives, polyvinyl carbazol, polyvinylpyrene and polyacenaphthylene.

As the binder of the charge transport layer, a resin which has an insulating property and/or is curable (crosslinkable) by heat and/or light in a conventional reaction condition to form a coating, e.g., a thermal curing resin or an UV curing resin, can be used without limitation. Examples of the binder include a silicone resin, a polyamide resin, a polyurethane resin, a polyester resin, an epoxy resin, a polyketone resin, a polycarbonate resin, a polycarbonate copolymer, a polyestercarbonate resin, a polyformal resin, poly(2,6-dimethylphenyleneoxide), a polyvinylbutyral resin, a polyvinylacetal resin, a styrene-acryl copolymer, a polyacryl resin, a polystyrene resin, a melamine resin, a styrene-butadiene copolymer, a polymethylmethacrylate resin, polyvinylchloride, an ethylene-vinyl acetate copolymer, a vinylchloride-vinylacetate copolymer, a polyacrylamide resin, polyvinylcarbazol, polyvinylpyrazoline, polyvinylpyrene, and a polyester copolymer. These binder compounds may be used alone or in a mixture form.

In the charge transport layer of the organic photoreceptor according to the present invention, the binder is used in an amount of 40 to 60 parts by weight based on 100 parts by weight of the charge transport layer composition.

Examples of the organic solvent used for the charge transport layer composition include aromatic solvents, e.g., toluene, xylene or anisol; ketone solvents, e.g., cyclohexanone or methylcyclohexanone; halide hydrocarbon solvents, e.g., methylene chloride or tetrachlorocarbon; and ether solvents, e.g., tetrahydrofuran, 1,3-dioxolan or 1,4-dioxane. These solvents may be used alone or in a mixture form.

Examples of the charge generating material include metal-free phthalocyanine (e.g., Progen 1×-form metal-free phthalocyanine, ZENECA INC.), and metal phthalocyanine such as titanium phthalocyanine, copper phthalocyanine, oxytitanium phthalocyanine, or hydroxygallium phthalocyanine.

The binder for the charge generating layer forming composition dissolves or disperses the charge generating material. Examples thereof include polyvinyl butyral, polycarbonate, polyvinyl alcohol, poly(styrene-co-butadiene), modified acryl polymer, polyvinyl acetate, styrene-alkyd resin, soya-alkyl resin, polyvinyl chloride, polyvinylidene chloride, polyacrylonitrile, polyacrylic acid, polyacrylate, polymethacrylate, styrene polymer, alkyd resin, polyamide, polyurethane, polyester, polysulfone, polyether and mixtures thereof.

In the charge generating layer forming composition, the charge generating material is used in an amount of 55 to 85 parts by weight and the binder is used in an amount of 15 to 45% by weight, based on the whole amount of solid content of the charge generating layer forming composition. If the amount of the charge generating material is out of the range specified above, charge generating capability is undesirably poor. If the amount of the binder is less than 15% by weight, bondability between the charge transport layer and the charge generating layer is lowered. If the amount of the binder is greater than 45% by weight, the content of the charge generating material in the charge generating layer is relatively lowered, and a charge generating capability is reduced.

Examples of the organic solvent used in the charge generating layer forming composition include alcoholic solvents such as methanol, ethanol or butanol, and acetate-based solvents such as ethyl acetate or butyl acetate. The solvent may be used alone or in a mixture form.

Although there is no restriction in coating methods of the charge generating layer composition and the charge transport layer composition, ring coating or dip coating is preferred in the case of a drum-like electrically conductive support.

As described above, the overcoat layer composition is coated on the photosensitive layer and dried to form an overcoat layer and then the electrophotographic photoreceptor is finally formed. The drying is preferably performed at a temperature in the range of 80 to 140° C., preferably 90 to 120° C.

As the coating method of the overcoat layer composition, spin coating, dip coating or ring coating is preferably used. When the electrically conductive support is in the form of a drum, ring coating or dip coating is preferred.

In the organic photoreceptor according to the present invention, the overall thickness of a photosensitive layer ranges from 5.2 to 31 μm. In particular, the charge generating layer has a thickness of 0.1 to 1.0 μm, the charge transport layer has a thickness of 5 to 25 μm, and the overcoat layer has a thickness of 0.1 to 5 μm. The electrically conductive support, in particular, a drum base, has a thickness of 0.5 to 2 mm.

The organic photoreceptor according to the present invention may further include additional layers. Such additional layers are generally known layers, for example, a charge blocking layer. The charge blocking layer 8 may be formed between the conductive base 1 and the charge transport layer 2, improving adhesion there between.

In the electrophotographically imaging process using the organic photoreceptor, dry-or liquid toner may be used.

In electrophotography, when the organic photoreceptor for conventional dry-type toner is applied to liquid toner, and contacts a paraffinic solvent, one of the main components of the liquid toner, the organic photoreceptor of the present invention may become cracked or crazed, or some components of the organic photoreceptor may be eluted.

On the other hand, since the organic photoreceptor according to the present invention has a high resistance to a paraffinic solvent, the organophotoreceptor of the present invention may be advantageously used in an electrophotographic imaging process using liquid toner, and the above-described problems can be avoided. Also, the organic photoreceptor according to the present invention has good wear resistance in the presence of liquid toner.

As described above, the surface of the organic photoreceptor is electrostatically uniformly charged and the charged surface is exposed by irradiating light imagewise, thus forming an electrostatic latent image on the surface of the organic photoreceptor. Subsequently, the surface of the organic photoreceptor having the electrostatic latent image contacts the liquid toner for development, and a temporary image is formed. Thereafter, the image is transferred onto the surface of a receptor, such as paper or an intermediate transfer medium.

The liquid toner is manufactured by dispersing a colorant, a charge control agent, a binder resin and the like, in a solvent. Hydrocarbon-based solvents, including aliphatic hydrocarbons, e.g., n-pentane, hexane or heptane, alicyclic hydrocarbons, e.g., cyclopentane or cyclohexane, aromatic hydrocarbons, e.g., benzene, toluene or xylene, halogenated hydrocarbons, e.g., chlorinated alkane or chlorofluorocarbon, silicon oils or mixtures thereof may be used as the solvent. Specifically, aliphatic hydrocarbon solvents, in particular, paraffin solvent mixtures such as ISOPAR G, H, L, K, V or M, or NORPAR 12, 13, or 15 (Trade name) available from EXXON, are preferably used. The amount of the solvent is 5 to 100 parts by weight based on 1 part by weight of the colorant.

Useful colorants are well known in the art, and include materials such as dyes, stains, and pigments. Examples of suitable colorants include, but are not limited to, phthalocyanine blue (C.I. PIGMENT BLUE), monoarylide yellow, diarylide yellow, arylamide yellow, azo red, quinacridone magenta and black pigments, such as finely divided carbon, and the like.

Hereinafter, the present invention will be described in greater detail with reference to the following examples. The following examples are for illustrative purposes and are not intended to limit the scope of the invention.

### EXAMPLE 1

Preparation of Charge Transport Layer:

1.15 g of a compound as a first charge transporting material represented by Formula 1, 1.15 g of a compound as a second charge transporting material represented by Formula 2, 0.23 g of a polyethyleneterephthalate copolymer (O-PET4-50, KANEBO, Japan) and 2.07 g of polycarbonate (PCZ200, MITSUBISHI CHEMICAL, Japan) were dissolved in 15.4 g of tetrahydrofuran (THF), filtered using a filter having a pore size of 1 μm, giving a charge transport layer forming composition. The composition was coated on an aluminum drum at a speed of 300 mm/min using a ring coater, and dried at 110° C. for 15 minutes to form a charge transport layer having a thickness of approximately 8 μm.

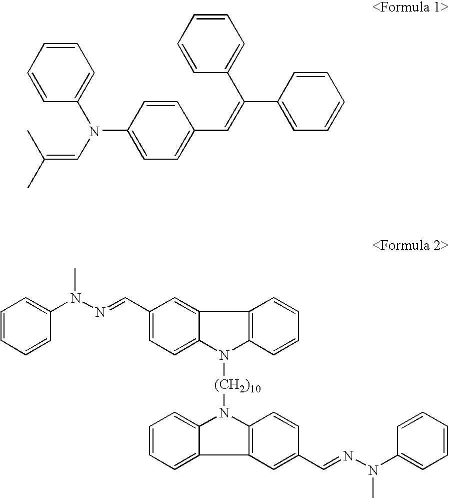

Preparation of Charge Generating Layer:

0.84 g of polyvinylbutyral (BX-1, SEKISUI, Japan) was dissolved in 17.2 g of ethanol and 1.96 g of titanyloxy phthalocyanine as a charge generating material (TiOPc, H. W. SANDS) was added, followed by mixing. The mixed dispersion was milled using an attritor-type milling machine for 1 hour, giving a dispersed solution (14%). To 0.08 g of a third charge transporting material represented by Formula 3 were added 7.68 g of butylacetate and 6.61 g of ethanol for dissolution, followed by mixing 5.71 g of the resulting dispersed solution, thereby preparing a charge generating layer coating solution. The charge generating layer coating solution was filtered using a filter having a pore size of 5 μm, and then coated on the charge transport layer at a speed of 250 mm/min using a ring coater, followed by drying at 110° C. for 15 minutes, thereby forming a charge generating layer having a thickness of 0.3 μm.

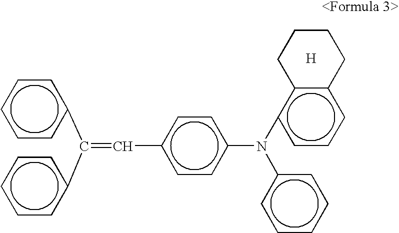

Preparation of Overcoat Layer:

0.42 g of Teflon PTFE 30 (aqueous PTFE dispersion, 40% of solid matter, an average particle size of 0.22 μm; DU PONT, USA), 15.43 g of distilled water and 1.90 g of isopropyl alcohol were mixed and 2.50 g of HWU305A (anionic aqueous polyurethane dispersion, 40% of solid matter, HEPCE CHEM CO., Korea) was added thereto, followed by performing ultrasonic wave treatment for one hour, giving a coating solution. The coating solution was filtered using a filter having a pore size of 5 μm, and coated on the charge generating layer using a ring coater at a speed of 200 mm/min and dried at 120° C. for 20 minutes, thereby obtaining an overcoat layer.

### EXAMPLE 2

An organic photoreceptor was manufactured in the same manner as in Example 1 except that 15.27 g of distilled water and 0.83 g of Teflon PTFE 30 were used.

### EXAMPLE 3

An organic photoreceptor was manufactured in the same manner as in Example 1 except that 15.10 g of distilled water and 1.25 g of Teflon PTFE 30 were used.

### EXAMPLE 4

An organic photoreceptor was manufactured in the same manner as in Example 1 except that 14.93 g of distilled water and 1.67 g of Teflon PTFE 30 were used.

### COMPARATIVE EXAMPLE 1

An organic photoreceptor was manufactured in the same manner as in Example 1 except that 3 g of polyurethane acrylic hybrid dispersion (Hybridur-580 having 10% of solid matter, AIR PRODUCTS AND CHEMICALS, INC., U.S.A.), 8.5 g of distilled water and 8.5 g of ethanol were mixed for dilution.

### EXPERIMENTAL EXAMPLE 1

### Evaluation of Electrical Properties

Electrostatic properties of the organic photoreceptors employing overcoat layers prepared in Examples 1-4 and Comparative Example 1 were evaluated by measuring changes in charge potential and exposure potential using charge-exposure-erase cycling as shown in FIG. 4 under conditions of a linear drum speed of 5.0 inch/sec and laser power of 0.3 mW, and the evaluation results are shown in Table 1.

### EXPERIMENTAL EXAMPLE 2

### Evaluation of Relative Friction Coefficient

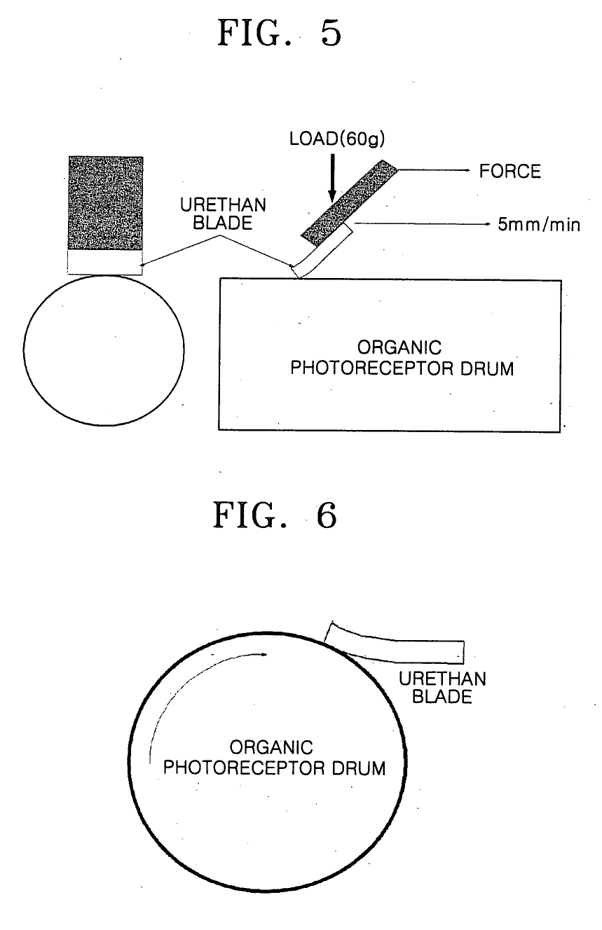

Force in a direction in which organic photoreceptors were moved using an evaluating apparatus (FIG. 5) with a load of 60 g at a speed of 5 mm/min was measured at least five times and an average was obtained. Also, it was determined whether the organic photoreceptors could be rotated using a blade contact rotating apparatus shown in FIG. 6 in a state where they contact a cleaning blade.

TABLE 1

| | | | | | Comparative |
|---|---|---|---|---|---|
| Evaluation Item | Example 1 | Example 2 | Example 3 | Example 4 | Example 1 |
| Charge potential (V) | 900→910 | 925→915 | 900→900 | 900→900 | 900→860 |
| Exposure potential (V) | 130→140 | 130→130 | 130→125 | 130→125 | 130→155 |
| Relative frictional force (g) | 19.8 | 17.5 | 13.7 | 12.1 | 25.3 |
| Rotatability | Rotatable | Rotatable | Rotatable | Rotatable | Not Rotatable |

Charge-Exposure-Erase Cycling: (1^{st} Cycle)→(3000^{th} Cycle)

As shown in Table 1, in Examples 1 through 4, it was confirmed that the relative frictional force with respect to the cleaning blade was reduced as the fluorine resin particle content contained in the overcoat layer composition increased. Also, when the fluorine resin particle content was greater than 25 parts by weight per 100 parts by weight of solid content of aqueous polyurethane dispersion, the frictional force relative to the cleaning blade was reduced so that the organic photoreceptor could rotate even when there was no aliphatic hydrocarbon used as liquid toner or a liquid toner carrier. Whereas, as shown in the result of Comparative Example 1, when the overcoat layer without fluorine resin was coated, the frictional force was so high that the organic photoreceptor could not rotate.

Therefore, the anionic aqueous polyurethane dispersion and fluorine resin used in the present invention are successfully applied to an organic photoreceptor, particularly, an overcoat layer.

An overcoat layer having good electrical and mechanical properties is formed using an overcoat layer composition comprising the anionic aqueous polyurethane dispersion and the fluorine resin, thereby increasing a lifespan of an organic photoreceptor. In particular, the formed organic photoreceptor has high durability against liquid toner and abrasion resistance so that it can be advantageously used for a development system for the liquid toner.

Also, the fluorine resin added to the composition reduces frictional coefficient with respect to a cleaning blade, thereby preventing overload due to frictional force applied when the organic photoreceptor rotates, preventing the cleaning blade from bending, allowing the organic photoreceptor to rotate without addition of a special lubricant, and enhancing cleaning performance of toner developed on the photoreceptor.

When the overcoat layer composition according to the present invention is coated on a photosensitive layer, the photosensitive layer is minimally affected by foreign matter. Also, since the overcoat layer composition is highly stable, it can be advantageous for mass production.

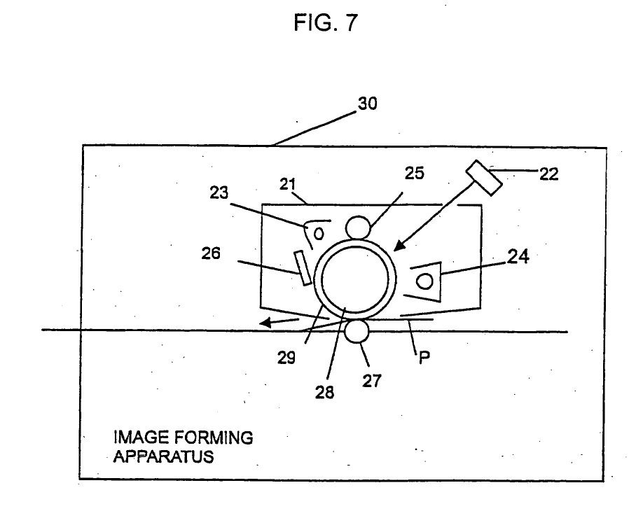

FIG. 7 is a schematic representation of an image forming apparatus 30. The electrophotographic imaging apparatus 30 includes a photoreceptor unit. The photoreceptor unit generally includes a drum 28 that is attachable to and detachable from the electrophotographic apparatus 30, and an organic photoreceptor 29 disposed on the drum 28. The imaging apparatus further includes a charging device 25 which charges the photoreceptor unit, an imagewise light irradiating device 22 which irradiates the charged photoreceptor unit with imagewise light to form an electrostatic latent image with a toner to form a toner image on the photoreceptor unit, and a transfer device 27, which transfers the toner image onto a receiving material, such as paper P. The charging device 25 may be supplied with a voltage as a charging unit and may contact and charge the organic photoreceptor 29. Where desired, the apparatus may also include a pre-exposure unit 23 to erase residual charge on the surface of the organic photoreceptor 29 to prepare for a next cycle. The imaging apparatus further includes an electrophotographic cartridge 21, a developing device 24 which develops an electrostatic latent image formed on the organic photoreceptor 29, and a cleaning device 26 which cleans a surface of the organic photoreceptor 29.

An electrophotographic imaging process using the organophotoreceptor according to the present invention will now be described.

First, the surface of an organic photoreceptor having an electrically conductive substrate, where a charge transport material and a charge generating material are provided, is uniformly electrostatically charged, and thereafter the charged surface is imagewise exposed to light. The light exposure selectively dissipates the charge in illuminated areas, thereby forming a pattern of charged and uncharged areas. Finally, a liquid toner is deposited on the surface to create a toner image on the surface of the substrate. The resulting toner image can be transferred to a suitable receiving surface such as paper. The imaging process may be repeated many times.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An overcoat layer composition comprising an anionic aqueous polyurethane dispersion and a fluorine resin.

2. The overcoat layer composition of claim 1, wherein the fluorine resin is particle-shaped.

3. The overcoat layer composition of claim 1, wherein the fluorine resin is polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), or a mixture thereof.

4. The overcoat layer composition of claim 1, wherein the fluorine resin is polytetrafluoroethylene.

5. The overcoat layer composition of claim 2, wherein an average particle size of the fluorine resin is preferably 0.1 to 1 μm.

6. The overcoat layer composition of claim 1, wherein the fluorine resin is used in an amount of 20 to 200 parts by weight per 100 parts by weight of solid content of the anionic aqueous polyurethane dispersion.

7. The overcoat layer composition of claim 1, further comprising a fluorine-containing dispersant in an amount of 1 to 10 parts by weight per 100 parts by weight of solid content of the fluorine resin.

8. The overcoat layer composition of claim 1, wherein a fluorine-containing dispersant is a non-ionic compound.

9. The overcoat layer composition of claim 1, wherein the anionic aqueous polyurethane dispersion is obtained by reacting at least one acid anhydride with or without a double bond with at least one kind of triol or tetraol derivatives to prepare a diol or triol monomer, or a mixture thereof containing a carboxyl group or containing both a carboxyl group and a double bond, reacting the resulting product with polyol, and diisocyanate or diisocyanate polymer to acquire a polyurethane prepolymer, neutralizing a carboxylic group of the acquired polyurethane prepolymer using a neutralizer and dispersing the same in water, followed by chain-extending using a chain extending agent.

10. The overcoat layer composition of claim 9, wherein the neutralizer is water-soluble tertiary amine, alkali metal hydroxide or a mixture thereof.

11. The overcoat layer composition of claim 9, wherein the chain extending agent is at least one selected from the group consisting of diol, triol, diamine, triamine, hydrazine and dihydrazide and having two reactive hydrogen atoms and having a molecular weight of 18 to 250.

12. The overcoat layer composition of claim 9, wherein an NCO content of the polyurethane prepolymer acquired is 0.1 to 30%.

13. The overcoat layer composition of claim 9, wherein the water used during dispersion for a total solid content is 5 to 80% and a temperature of the water is in the range of 5 to 80° C.

14. The overcoat layer composition of claim 1, further comprising a polymerization initiator.

15. The overcoat layer composition of claim 1, further comprising water or a mixed solvent of water and alcohol for dilution, the water or mixed solvent being used for the total solid content of the composition.

16. An organic photoreceptor comprising: an electrically conductive support, and a photosensitive layer formed on the electrically conductive support, wherein the photosensitive layer further comprises an overcoat layer composition comprising an anionic aqueous polyurethane dispersion and a fluorine resin.

17. The organic photoreceptor of claim 16, wherein the overcoat layer has a thickness of 0.1 to 5 μm.

18. The organic photoreceptor of claim 16, wherein the photosensitive layer has a single layered structure having a charge generating material and a charge transport material.

19. The organic photoreceptor of claim 16, wherein the photosensitive layer has a dual layered structure having a charge transport layer including a charge transport material and a charge generating layer including a charge generating material.

20. The organic photoreceptor of claim 16, wherein the fluorine resin is particle-shaped.

21. The organic photoreceptor of claim 16, wherein the fluorine resin is polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), or a mixture thereof.

22. The organic photoreceptor of claim 16, wherein the fluorine resin is polytetrafluoroethylene.

23. The organic photoreceptor of claim 17, wherein an average particle size of the fluorine resin is preferably 0.1 to 1 μm.

24. The organic photoreceptor of claim 16, wherein the fluorine resin is used in an amount of 20 to 200 parts by weight per 100 parts by weight of solid content of the anionic aqueous polyurethane dispersion.

25. The organic photoreceptor of claim 16, further comprising a fluorine-containing dispersant in an amount of 1 to 10 parts by weight per 100 parts by weight of solid content of the fluorine resin.

26. The organic photoreceptor of claim 25, wherein the fluorine-containing dispersant is a non-ionic compound.

27. The organic photoreceptor of claim 16, wherein the anionic aqueous polyurethane dispersion is obtained by reacting at least one acid anhydride with or without a double bond with at least one kind of triol or tetraol derivatives to prepare a diol or triol monomer, or a mixture thereof containing a carboxyl group or containing both a carboxyl group and a double bond, reacting the resulting product with polyol, and diisocyanate or diisocyanate polymer to acquire a polyurethane prepolymer, neutralizing a carboxylic group of the acquired polyurethane prepolymer using a neutralizer and dispersing the same in water, followed by chain-extending using a chain extending agent.

28. The organic photoreceptor of claim 27, wherein the neutralizer is water-soluble tertiary amine, alkali metal hydroxide or a mixture thereof.

29. The organic photoreceptor of claim 27, wherein the chain extending agent is at least one selected from the group consisting of diol, triol, diamine, triamine, hydrazine and dihydrazide and having two reactive hydrogen atoms and having a molecular weight of 18 to 250.

30. The organic photoreceptor of claim 25, wherein an NCO content of the polyurethane prepolymer acquired is 0.1 to 30%.

31. The organic photoreceptor of claim 25, wherein the water is used during dispersion for a total solid content is 5 to 80% and a temperature of the water is in the range of 5 to 80° C.

32. The organic photoreceptor of claim 16, further comprising a polymerization initiator.

33. The organic photoreceptor of claim 16, further comprising water or a mixed solvent of water and alcohol for dilution, the water or mixed solvent being used for the total solid content of the composition.

34. An electrophotographic imaging method using liquid toner, the method comprising:
electrostatically charging a surface of an organic photoreceptor having an electrically conductive substrate, and a photosensitive layer formed on the electrically conductive substrate,
exposing the charged surface of the organic photoreceptor to light, dissipating a charge in illuminated areas, forming a pattern of charged and uncharged areas;
depositing the liquid toner on the surface to the organic photoreceptor creating a toner image on the surface of the electrically conductive substrate;
transferring the image to a receiving surface;
repeating the imaging process a predetermined amount of times,
wherein the photosensitive layer comprises an overcoat layer composition including an anionic aqueous polyurethane dispersion and a fluorine resin.

35. The electrophotographic imaging method of claim 34, wherein the liquid toner includes an aliphatic hydrocarbon solvent.

36. The electrophotographic imaging method of claim 34, wherein the fluorine resin is particle-shaped.

37. The electrophotographic imaging method of claim 34, wherein the fluorine resin is polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), or a mixture thereof.

38. The electrophotographic imaging method of claim 34, wherein the fluorine resin is polytetrafluoroethylene.

39. The electrophotographic imaging method of claim 35, wherein an average particle size of the fluorine resin is preferably 0.1 to 1 μm.

40. The electrophotographic imaging method of claim 34, wherein the fluorine resin is used in an amount of 20 to 200 parts by weight per 100 parts by weight of solid content of the anionic aqueous polyurethane dispersion.

41. The electrophotographic imaging method of claim 34, further comprising a fluorine-containing dispersant in an amount of 1 to 10 parts by weight per 100 parts by weight of solid content of the fluorine resin.

42. The electrophotographic imaging method of claim 41, wherein the fluorine-containing dispersant is a non-ionic compound.

43. The electrophotographic imaging method of claim 34, wherein the anionic aqueous polyurethane dispersion is obtained by reacting at least one acid anhydride with or without a double bond with at least one kind of triol or tetraol derivatives to prepare a diol or triol monomer, or a mixture thereof containing a carboxyl group or containing both a carboxyl group and a double bond, reacting the resulting product with polyol, and diisocyanate or diisocyanate polymer to acquire a polyurethane prepolymer, neutralizing a carboxylic group of the acquired polyurethane prepolymer using a neutralizer and dispersing the same in water, followed by chain-extending using a chain extending agent.

44. The electrophotographic imaging method of claim 43, wherein the neutralizer is water-soluble tertiary amine, alkali metal hydroxide or a mixture thereof.

45. The electrophotographic imaging method of claim 43, wherein the chain extending agent is at least one selected from the group consisting of diol, triol, diamine, triamine, hydrazine and dihydrazide and having two reactive hydrogen atoms and having a molecular weight of 18 to 250.

46. The electrophotographic imaging method of claim 43, wherein an NCO content of the polyurethane prepolymer acquired is 0.1 to 30%.

47. The electrophotographic imaging method of claim 43, wherein the water used during dispersion for a total solid content is 5 to 80% and a temperature of water is in the range of 5 to 80° C.

48. An electrophotographic cartridge, comprising:
an organic photoreceptor comprising an electrically conductive support, and a photosensitive layer formed on the electrically conductive support;
a charging device that charges the organic photoreceptor;
a developing device which develops an electrostatic latent image formed on the organic photoreceptor; and
a cleaning device which cleans a surface of the organic photoreceptor;
wherein the electrophotographic cartridge is attachable to or detachable from an image forming apparatus, and
wherein the photosensitive layer further comprises an overcoat layer composition comprising an anionic aqueous polyurethane dispersion and a fluorine resin.

49. The electrophotographic cartridge of claim 48, wherein the fluorine resin is particle-shaped.

50. The electrophotographic cartridge of claim 48, wherein the fluorine resin is polytetrafluoroethylene (PTFE), polyvinylidenefluoride (PVDF), a fluorinated ethylene propylene copolymer (FEP), a polyethylenetetrafluoroethylene copolymer (PE-TFE), a polyfluoroalkoxy copolymer (PFA), polyvinylfluoride (PVF), or a mixture thereof.

51. The electrophotographic cartridge of claim 48, wherein the fluorine resin is polytetrafluoroethylene.

52. The electrophotographic cartridge of claim 49, wherein an average particle size of the fluorine resin is preferably 0.1 to 1 μm.

53. The electrophotographic cartridge of claim 48, wherein the fluorine resin is used in an amount of 20 to 200 parts by weight per 100 parts by weight of solid content of the anionic aqueous polyurethane dispersion.

54. The electrophotographic cartridge of claim 54, further comprising the fluorine-containing dispersant in an amount of 1 to 10 parts by weight per 100 parts by weight of solid content of the fluorine resin.

55. The electrophotographic cartridge of claim 54, wherein the fluorine-containing dispersant is a non-ionic compound.

56. The electrophotographic cartridge of claim 48, wherein the anionic aqueous polyurethane dispersion is obtained by reacting at least one acid anhydride with or without a double bond with at least one kind of triol or tetraol derivatives to prepare a diol or triol monomer, or a mixture thereof containing a carboxyl group or containing both a carboxyl group and a double bond, reacting the resulting product with polyol, and diisocyanate or diisocyanate polymer to acquire a polyurethane prepolymer, neutralizing a carboxylic group of the acquired polyurethane prepolymer using a neutralizer and dispersing the same in water, followed by chain-extending using a chain extending agent.

57. The electrophotographic cartridge of claim 56, wherein the neutralizer is water-soluble tertiary amine, aikali metal hydroxide or a mixture thereof.

58. The electrophotographic cartridge of claim 56, wherein the chain extending agent is at least one selected from the group consisting of diol, triol, diamine, triamine, hydrazine and dihydrazide and having two reactive hydrogen atoms and having a molecular weight of 18 to 250.

59. The electrophotographic cartridge of claim 56, wherein an NCO content of the polyurethane prepolymer acquired is 0.1 to 30%.

60. The electrophotographic cartridge of claim 56, wherein the water used during dispersion for a total solid content is 5 to 80% and a temperature of water is in the range of 5 to 80° C.

61. The electrophotographic cartridge of claim 48, further comprising a polymerization initiator.

62. The electrophotographic cartridge of claim 48, further comprising water or a mixed solvent of water and alcohol for dilution, the water or mixed solvent being used for the total solid content of the composition.

63. The electrophotographic cartridge of claim 48, wherein the overcoat layer has a thickness of 0.1 to 5 μm.

64. The electrophotographic cartridge of claim 48, wherein the photosensitive layer has a single layered structure having a charge generating material and a charge transport material.

65. The electrophotographic cartridge of claim 48, wherein the photosensitive layer has a dual layered structure having a charge transport layer including a charge transport material and a charge generating layer including a charge generating material.
